(19) United States
(12) Patent Application Publication
(10) Pub. No.: US 2025/0150467 A1
(43) Pub. Date: May 8, 2025

(54) DEVICES, SYSTEMS, AND METHODS FOR REMOTELY MANAGING ANOTHER ORGANIZATIONS SECURITY ORCHESTRATION, AUTOMATION, AND RESPONSE

(71) Applicant: BlueVoyant LLC, New York, NY (US)

(72) Inventors: Dorian Birsan, Ontario (CA); Christopher Teekema, New York (CA); Neel Arora, New York, NY (US)

(73) Assignee: BlueVoyant LLC, New York, NY (US)

(21) Appl. No.: 18/833,265

(22) PCT Filed: Jan. 23, 2023
(86) PCT No.: PCT/US2023/061069

§ 371 Date: Jul. 25, 2024

Related U.S. Application Data
(60) Provisional application No. 63/302,828, filed on Jan. 25, 2022.

(51) Int. Cl. H04L 9/40

(52) U.S. Cl. CPC H04L 63/1416; H04L 63/105; H04L 63/1441

(57) ABSTRACT

A security automation platform is disclosed herein. The security automation platform can be communicably coupled to a tenant configured to deploy a tenant security platform and comprises a processor and a memory configured to store a security automation platform that, when executed by the processor, causes the processor to detect, via a variable store, a variable associated with the tenant, correlate, via a content library, the detected variable to an artifact stored within the content library; generate, via an automation schema, an automation for the tenant based on the artifact, wherein the automation comprises a security tool configured to continuously monitor an API deployed by the tenant, and transmit, via an API broker of the security automation platform, the generated automation to the security automation platform deployed by the tenant.

### CROSS-REFERENCE TO RELATED APPLICATIONS

This application is a U.S. National Stage Entry under 35 U.S.C. § 371 of International Patent Application No. PCT/US2023/061069, filed Jan. 23, 2023, entitled DEVICES, SYSTEMS, AND METHODS FOR REMOTELY MANAGING ANOTHER ORGANIZATION'S SECURITY ORCHESTRATION, AUTOMATION, AND RESPONSE, which claims benefit under under 35 U.S.C. § 119 (e) to U.S. Provisional Patent Application No. 63/302,828, titled DEVICES, SYSTEMS, AND METHODS FOR REMOTELY MANAGING ANOTHER ORGANIZATIONS SECURITY, ORCHESTRATION, AUTOMATION, AND RESPONSE filed Jan. 25, 2022, the disclosure of which is hereby incorporated by reference in its entirety.

### FIELD

The present disclosure is generally related to network security, and, more particularly, is directed to improved devices, systems, and methods for managing Security Orchestration, Automation, and Response (SOAR) platforms.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a Security Orchestration, Automation, and Response (SOAR) management server is disclosed herein. The SOAR management server can be communicably coupled to a tenant configured to deploy a SOAR platform and can include a processor and a memory. The memory can be configured to store a SOAR management application including a content library, a variable store, an automation schema, and an application program interface (API) broker. When executed by the processor, the SOAR management application can cause the processor to: detect, via the variable store, a variable associated with the tenant; correlate, via the content library, the detected variable to an artifact stored within the content library; generate, via the automation schema, an automation for the tenant based on the artifact, wherein the automation includes a security tool configured to continuously monitor an API deployed by the tenant; transmit, via the API broker of the SOAR management application, the generated automation to the SOAR platform deployed by the tenant.

In various aspects, a method for enhancing network security via a SOAR management server is disclosed. The SOAR management server can be communicably coupled to a tenant configured to deploy a SOAR platform and the SOAR management server can include a processor; and a memory configured to store a SOAR management application. The SOAR management application can include a content library, a variable store, an automation schema, and an application program interface (API) broker. The method can include: detecting, via the variable store, a variable associated with the tenant; correlating, via the content library, the detected variable to an artifact stored within the content library; generating, via the automation schema, an automation for the tenant based on the artifact, wherein the automation includes a security tool configured to continuously monitor an API deployed by the tenant; and transmitting, via the API broker of the SOAR management application, the generated automation to the SOAR platform deployed by the tenant.

In various aspects, a system for enhancing network security by remotely managing a SOAR platform is disclosed. The system can include a tenant configured to deploy the SOAR platform and a SOAR management server communicably coupled to the tenant, wherein the SOAR management server can include a processor and a memory. The memory can be configured to store a SOAR management application including a content library, a variable store, an automation schema, and an application program interface (API) broker. When executed by the processor, the SOAR management application can cause the processor to: detect, via the variable store, a variable associated with the tenant; correlate, via the content library, the detected variable to an artifact stored within the content library; generate, via the automation schema, an automation for the tenant based on the artifact, wherein the automation includes a security tool configured to continuously monitor an API deployed by the tenant; transmit, via the API broker of the SOAR management application, the generated automation to the SOAR platform deployed by the tenant.

These, and other objects, features, and characteristics of the present invention, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the invention.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates a system configured to remotely manage another organization's Security Orchestration, Automation, and Response (“SOAR”), in accordance with at least one non-limiting aspect of the present disclosure;

FIG. 2 illustrates a functional architecture of the system of FIG. 1, in accordance with at least one non-limiting aspect of the present disclosure;

FIG. 3 illustrates a method of remotely managing another organization's SOAR, in accordance with at least one non-limiting aspect of the present disclosure;

FIG. 4 illustrates a graphical user interface configured to interface with the functional architecture of FIG. 2, in accordance with at least one non-limiting aspect of the present disclosure; and

FIG. 5 illustrates a scalable security information and event management framework, in in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

The Applicant of the present application owns the following U.S. Provisional Patent Applications, the disclosure of each of which is herein incorporated by reference in its entirety:
U.S. Provisional Patent Application No. 63/295,150 titled DEVICES, SYSTEMS, AND METHODS FOR STREAMLINING AND STANDARDIZING THE INGEST OF SECURITY DATA ACROSS MULTIPLE TENANTS, filed on Dec. 30, 2021;
U.S. Provisional Patent Application No. 63/302,828 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 25, 2022;
U.S. Provisional Patent Application No. 63/313,422 titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 24, 2022;
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 202;
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022
International Patent Application No. PCT/US22/72739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022;
International Patent Application No. PCT/US22/72743, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 3, 2022;
U.S. Provisional Patent Application No. 63/365,819 titled DEVICES, METHODS, AND SYSTEMS FOR GENERATING A HIGHLY-SCALABLE, EFFICIENT COMPOSITE RECORD INDEX, filed on Jun. 3, 2022
U.S. Provisional Patent Application No. 63/353,992 titled DEVICES, SYSTEMS, AND METHODS FOR CATEGORIZING, PRIORITIZING, AND MITIGATING CYBER SECURITY RISKS, filed on Jun. 21, 2022;
U.S. Provisional Patent Application No. 63/366,903 titled DEVICES, SYSTEMS, AND METHOD FOR GENERATING AND USING A QUERYABLE INDEX IN A CYBER DATA MODEL TO ENHANCE NETWORK SECURITY, filed on Jun. 23, 2022;
U.S. Provisional Patent Application No. 63/368,567 titled DEVICES, SYSTEMS, AND METHODS FOR UTILIZING A NETWORKED, COMPUTER-ASSISTED, THREAT HUNTING PLATFORM TO ENHANCE NETWORK SECURITY, filed on Jul. 15, 2022;
U.S. Provisional Patent Application No. 63/369,582 titled AUTONOMOUS THREAT SCORING AND SECURITY ENHANCEMENT, filed on Jul. 27, 2022;
U.S. Provisional Patent Application No. 63/377,304, titled DEVICES, SYSTEMS, AND METHODS FOR CONTINUOUSLY ENHANCING THE IMPLEMENTATION OF CODE CHANGES VIA ENRICHED PIPELINES, filed on Sep. 27, 2022; and

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative. Variations, and changes thereto may be made without departing from the scope of the claims. In the following description, like reference characters designate like or corresponding parts throughout the several views of the drawings.

Before explaining various aspects of the systems, and methods disclosed herein in detail, it should be noted that the illustrative aspects are not limited in application or use to the details of disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, software suite, application, or development platform disclosed herein is merely intended to illustrate several of the many aspects of the present disclosure. This includes any, and all references to trademarks. Accordingly, it shall be appreciated that the devices, systems, and methods disclosed herein can be implemented to enhance any software update, in accordance with any intended use, and/or user preference.

As used herein, the term “server” may refer to or include one or more computing devices that are operated by or facilitate communication, and processing for multiple parties in a network environment, such as the Internet or any public or private network. Reference to “a server” or “a processor,” as used herein, may refer to a previously-recited server, and/or processor that is recited as performing a previous step or function, a different server, and/or processor, and/or a combination of servers, and/or processors.

As used herein, the term “tenant” may refer to one or more client organizations managed by a managed security service provider (“MSSP”). Tenants can include one or more servers configured to manage a network, such as an intranet, by which numerous client instances are connected. For example, a “client” or “client instance,” as used herein, can include a computing device (e.g., a laptop, a desktop computer, a mobile phone, etc.) that is connected to the tenant's network. According to some non-limiting aspects, a “client” or “client instance” can be a software agent, or a computing device external to the tenant's network that is connected via a virtual private network (“VPN”) connection.

As used herein, the term “constant” may refer to one or more SIEM functions that remain unchanged during the issuance of an alert. For example, a constant can include an Azure Sentinel Log Analytics function, amongst others. According to some non-limiting aspects, a constant can be specifically configured in accordance with an individual client's preferences and/or requirements. For example, alert rules, as described herein, can be the same for all client deployments. However, the apparatuses, systems, and methods disclosed herein can employ client-specific constants to “fine tune” how alerts are managed for each particular client. In other words, each constant can include a whitelist of specific protocols, accounts, etc. which the alert rule manages those constants differently (e.g., skips them).

As used herein, the term “network” can include an entire enterprise information technology (“IT”) system, as deployed by a tenant. For example, a network can include a group of two or more nodes (e.g., assets) connected by any physical and/or wireless connection and configured to communicate and share information with the other node or nodes. However, the term network shall not be limited to any particular nodes or any particular means of connecting those nodes. A network can include any combination of assets (e.g., devices, servers, desktop computers, laptop computers, personal digital assistants, mobile phones, wearables, smart appliances, etc.) configured to connect to an ethernet, intranet, and/or extranet and communicate with one another via an ad hoc connection (e.g., Bluetooth®, near field communication (“NFC”), etc.), a local area connection (“LAN”), a wireless local area network (“WLAN”), and/or a virtual private network (“VPN”), regardless of each devices' physical location. A network can further include any tools, applications, and/or services deployed by devices, or otherwise utilized by an enterprise IT system, such as a firewall, an email client, document management systems, office systems, etc. In some non-limiting aspects, a “network” can include third-party devices, applications, and/or services that, although they are owned and controlled by a third party, are authorized by the tenant to access the enterprise IT system.

As used herein, the term “platform” can include software architectures, hardware architectures, and/or combinations thereof. A platform can include either a stand-alone software product, a network architecture, and/or a software product configured to integrate within a software architecture and/or a hardware architecture, as required for the software product to provide its technological benefit. For example, a platform can include any combination of a chipset, a processor, a logic-based device, a memory, a storage, a graphical user interface, a graphics subsystem, an application, and/or a communication module (e.g., a transceiver). In other words, a platform can provide the resources required to enable the technological benefits provided by software. According to some non-limiting aspects, the technological benefit provided by the software is provided to the physical resources of the ecosystem or other software employed by physical resources within the ecosystem (e.g., APIs, services, etc.). According to other non-limiting aspects, a platform can include a framework of several software applications intended and designed to work together.

An MSSP provides outsourced monitoring and management of security devices and systems on behalf of organizational clients. For example, an MSSP may provide clients with common services, including a managed firewall, intrusion detection, virtual private network, vulnerability scanning, and anti-viral services. An emerging trend in the MSSP industry is to develop technologies that are effectively three to five years ahead of what is available to the open market. For example, some proprietary security information and event management (“SIEM”) technologies were developed when it became apparent that MSSP's could not purchase them off-the-shelf. Following the development of proprietary SIEM technologies, MSSPs developed platforms for automating management of SIEM platforms for their clients in a scalable way, as the technology became generally available. A non-limiting example of one such scalable, automated SIEM platform is disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety.

Although SIEM platforms can analyze multiple data sources, perform sophisticated correlation to identify threats, and intelligently rank identified events in order of criticality, Security Orchestration, Automation, and Response (“SOAR”) platforms can be implemented to automate investigation path workflows based on SIEM-generated alerts to significantly cut down on the amount of time required to manage and mitigate security threats. SOAR platforms generally include a collection of security software solutions and tools for browsing and collecting diverse data from a variety of sources to be analyzed, in order to comprehend and prioritize security incident response actions. SOAR platforms can be used to describe several software capabilities, including threat and vulnerability management, security incident response, and security operations automation. In other words, SOAR platforms not only allow companies to collect threat-related data from a range of sources, but can identify and respond to identified threats based on the analysis. Once a threat is identified, the typical SOAR platform can secure the network by implementing an incident response that mitigates the identified threat.

Traditionally, SOAR platforms have been designed to automate an incident response lifecycle by increasing a cyber defense team's ability to detect, investigate, and respond to security alerts in a given environment, either manually or via the use of automation. However, in order to realize their full potential, SOAR platforms require a high degree of integration into an environment to realize their full potential, as well as customized playbooks and response activity. Accordingly, conventional SOAR platforms are generally managed by an implementing organization directly, because the organization is better positioned to integrate the platform into its network and is able to myopically manage its own, single network. In order for a SOAR platform to be managed by a service provider, manual integration would be required to achieve the proper degree of integration to fully protect the client organization's network. In other words, a lot of manual labor and thought is required to establish sufficient connections to the variety of SOAR platforms and application program interfaces (“API's”) implemented by each client organization.

This can result in a high cost for both the MSSP—who must hire more expensive specialists—and for the client organization, who often bears at least a portion of the increasing expenses. However, there is often an overlap between some of the deployment needs of varying client organizations. For example, many organizations utilize similar SOAR platforms and may require similar monitoring and management solutions. In such instances, asset reuse, re-deployment, and updates may lead to major cost reduction, and a simplicity of operation. Unfortunately, known SIEM tools are technologically incapable of taking advantage of such synergies. Thus, from the initial provisioning, and throughout the automation of incident responses, MSSPs are left with limited re-use opportunities to capture efficiencies across multiple clients. Not only can a lack of reusable deployments be extremely expensive, but it can also be inherently unscalable, as each client organization's network is different, has different capabilities of detection, and has different levels of risk tolerance. Many client organizations may be skeptical and hesitant to proceed with an automated SOAR platform that, at a minimum, may mitigate the expense driven by manual implementation, although automation alone won't enhance the scalability of conventional SOAR platforms.

Accordingly, there is a need for enhanced devices, systems, and methods for remotely managing another organization's SOAR. The devices, systems, and methods disclosed herein allow a service provider to centrally and remotely manage SOAR platforms with standardized content that is modular and thus, easily deliverable to client organizations to provide a comprehensive, well-integrated SOAR solution. The SOAR solutions provided by the enhanced devices, systems, and methods disclosed herein can deliver improved outcomes for client organizations without human intervention and can do so at a larger scale and a fraction of the cost relative to conventional, manually-integrated SOAR platforms, which require active human integration and continuous maintenance. The enhanced devices, systems, and methods for disclosed herein can be implemented to serve as a centralized platform to remotely manage another organization's SOAR by overcoming the aforementioned challenges and extending beyond the delivery of simple management of the systems and content. Rather the enhanced devices, systems, and methods for remotely managing another organization's SOAR enable service providers to deliver scalable orchestration content and management to numerous client systems in a way that enables infinitely modular and/or flexible solutions to be customized, in accordance with each client's needs.

The present disclosure contemplates such devices, systems, and methods, all of which provide many technological benefits over conventional MSSP and SIEM platforms. For example, conventional MSSP devices, systems, and methods lack the automation, artifacts, and interfaces required to seamlessly scale an MSSP platform such that SIEM services can be provided to hundreds, if not thousands, of tenant networks. Rather, conventional MSSP devices, systems, and methods require manual integration and management, meaning they are less efficient and more expensive. Conventional MSSP devices, systems, and methods also require each tenant network to share the manual resources employed by the MSSP, rendering each tenant network less secure. In contrast, the devices, systems, and methods disclosed herein are highly automated and thus, configured to enable an MSSP to efficiently implement and continuously monitor a tenant's network in real-time with minimal manual intervention. Not only do conventional MSSP devices, systems, and methods lack such automation, but it would be highly impractical—if not impossible—for an MSSP to manually monitor hundreds, if not thousands, of tenant networks continuously and in real-time. The devices, systems, and methods disclosed herein are also technologically adaptable. In conjunction with the MSSP devices, systems, and methods disclosed herein being highly scalable, such adaptability enables and MSSP to track changes across a high volume of tenant deployments, monitor responses to those changes, and autonomously implement them for any applicable tenant deployment that could also benefit from them. In other words, the updates provided by the MSSP devices, systems, and methods disclosed facilitate a technological evolution, which enables the MSSP to provide higher levels of security with each new tenant deployment. Furthermore, the MSSP devices, systems, and methods disclosed herein are practically integrated such that they enable autonomous security enhancing actions, such as removal of suspect accounts, deletion of suspect files, autonomous alerting of security administrators, etc. These technological benefits will be described in further detail herein. In summary, conventional MSSP devices, systems, and methods are inherently more prone security events and thus, technologically less secure than the devices, systems, and methods disclosed herein.

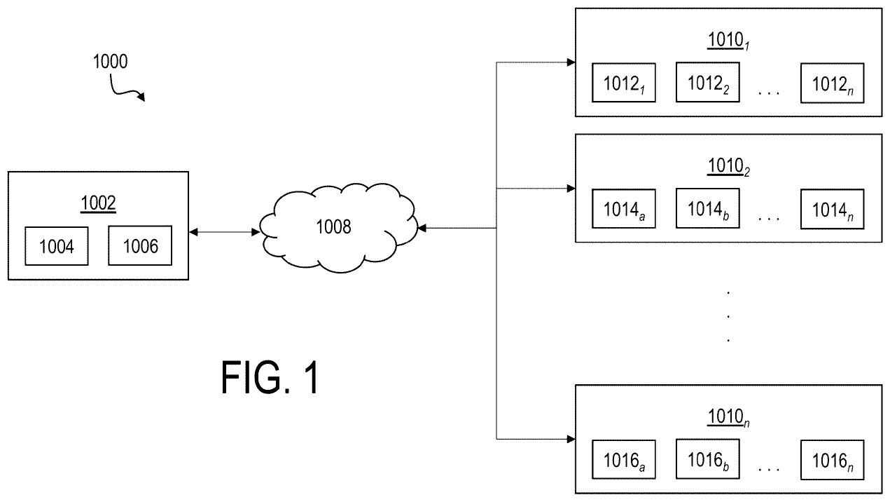

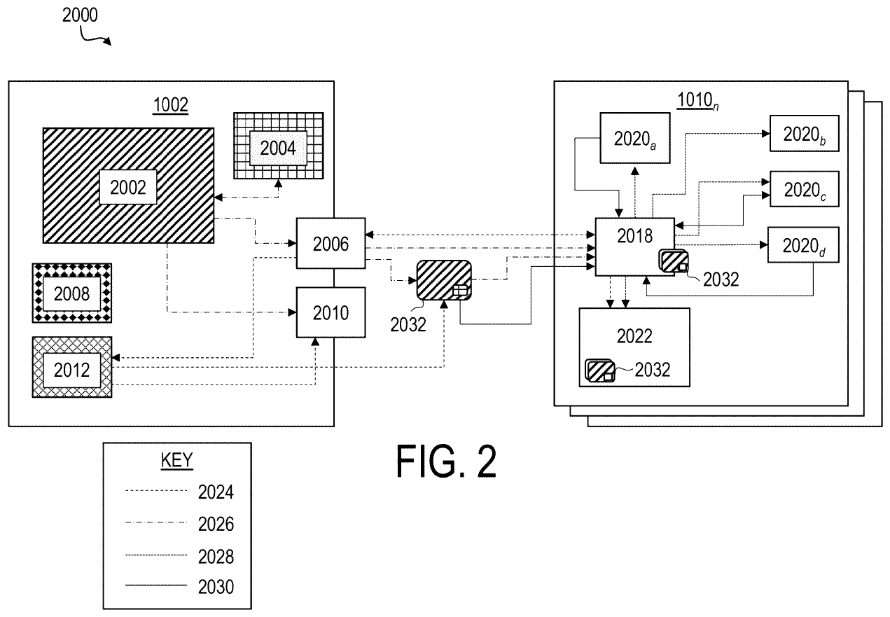

Referring now to FIG. 1, a block diagram of a system 1000 configured to remotely manage another organization's Security Orchestration, Automation, and Response (“SOAR”) is depicted in accordance with at least one non-limiting aspect of the present disclosure. According to the non-limiting aspect of FIG. 1, the system 1000 can include a SOAR management server 1002 comprising a memory 1006 configured to store a SOAR application (see FIG. 2), and a processor 1004 configured to execute the stored SOAR application (see FIG. 2), as will be discussed in further reference to FIG. 2. For example, the SOAR management server 1002 can be a computational resource either owned or leased by the managed security service provider (“MSSP”). The SOAR management server 1002 can be communicably coupled, via network 1008, to a plurality of tenants 1010a, 1010b . . . 1010n. Each tenant 1010₁, 1010₂ . . . 1010ₙ of the plurality can represent a customer (e.g., organization) contracting with the MSSP. According to the non-limiting aspect of FIG. 1, the network 1008 can include any variety of wired, long-range wireless, and/or short-range wireless networks. For example, the network 1008 can include an internal network, a Local Area Networks (LAN), WiFi®, cellular networks, near-field communication (hereinafter “NFC”), amongst others.

In further reference to FIG. 1, each tenant 1010₁, 1010₂ . . . 1010ₙ of the plurality can host one or more instances of one or more clients 1012, 1014, 1016. For example, a first tenant 1010₁ can include one or more machines implementing one or more client applications 1012₁, 1012₂ . . . 1012ₙ, a second tenant 1010₂ can include one or more machines implementing one or more client applications 1014₁, 1014₂ . . . 1014ₙ, and/or a third tenant 1010ₙ can include one or more machines implementing one or more client applications 1016₁, 1016₂ . . . 1016ₙ. Each tenant 1010₁, 1010₂, and 1010ₙ can include an intranet by which each machine implementing the client applications. For example, each tenant 1010₁, 1010₂, and 1010ₙ can each represent a customer, such as an organization, contracting with the MSSP for security services.

Accordingly, the SOAR management server 1002 can be configured to have oversight of each tenant 1010₁, 1010₂, and 1010ₙ of the plurality, and thus, is responsible for monitoring, and managing each client application 1012, 1014, 1016 for threats. As previously discussed, the differences, and complexity in tenant 1010₁, 1010₂, and 1010ₙ architecture can complicate this, and render it inefficient for the MSSP. Thus, known SOAR tools can leave the tenants 1010₁, 1010₂, and 1010ₙ technologically exposed, and thus, vulnerable to attacks. According to non-limiting aspects of the present disclosure, the SOAR management server 1002 can implement a SOAR management application (see FIG. 2) that technologically, and practically addresses these deficiencies by enhancing the ability of the SOAR management server 1002 to manage, and transmit alerts, and client application updates for multiple tenants based on correlated, and synergistic development needs. Moreover, the architecture 2000 of FIG. 2 further illustrates different means of communication between the various modules and

Referring now to FIG. 2, a block diagram of a functional architecture 2000 of the system 1000 of FIG. 1 is depicted in accordance with at least one non-limiting aspect of the present disclosure. According to the non-limiting aspect of FIG. 2, the architecture 2000 can include a content library 2002, a variable store 2004, an automation schema 2008, and a service operation engine 2012 collectively provided via an application stored in the memory 1006 (FIG. 1) of the SOAR management server 1002. According to some non-limiting aspects, the SOAR management server 1002 can be remotely located relative to the MSSP and/or tenant 1010ₙ . . . . For example, the SOAR management server 1002 may be cloud-based. When executed by the processor 1004 (FIG. 1), the application's content library 2002, variable store 2004, automation schema 2008, and service operation engine 2012 can collectively facilitate the simultaneous configuration, management, and/or control of multiple SOAR platforms 2018 for multiple tenants 1010ₙ, or client organizations, at scale. Moreover, when executed by the processor 1004 (FIG. 1), the application can support a client organization's SOAR platform 2018 in either an abstract or a dynamic way, as will be described in further detail herein.

According to some non-limiting aspects, the application deployed by the SOAR management server 1002 can be configured as an Azure Sentinel Automation Portal (ASAP), as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. For example, according to one non-limiting aspect, an ASAP portal runtime software code can include server middleware that is responsible for processing the content from the content library 2002, the connections to the SOAR platform 2018, and/or other services, and services requests for the SOAR management server 1002 to deploy, update, and/or read. In other words, the application deployed by the SOAR management server 1002, including the content library 2002, the variable store 2004, and the automation schema 2008, can provide a unified, simplified view of all tenant 1010₁₋ₙ (FIG. 1) deployments, in conjunction with an ability to work with one or multiple tenants 1010₁₋ₙ at the same time.

The content library 2002 can be configured to store various artifacts (e.g., detections, automations, workbooks, alert rules, playbooks, etc.) by which the SOAR management server 1002 can configure and manage a SOAR platform for one or more tenants 1010ₙ. According to some non-limiting aspects, the content library 2002 of FIG. 2 can be stored locally relative to the application, meaning it is provided via the memory 1006 (FIG. 1) of the SOAR management server 1002. However, according to other non-limiting aspects, the content library 2002 can be stored on a remote server communicably coupled to the SOAR management server 1002. In still other non-limiting aspects, the content library 2002 can be provided by a third-party provider (e.g., GitHub, GitLab, etc.), similar to those disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. In summary, the content library 2002—and more specifically, artifacts stored within the content library 2002—controls rules by which the SOAR management server 1002 can remotely interface with and/or manage a SOAR platform 2018 for the tenant 1010ₙ, or client organization. For example, the content library 2002 can store one or more rules and/or a template configured to automate the deactivation of a user account if the SOAR management server 1002 and/or SOAR platform 2018 determines that, based on detected variables throughout the tenant architecture 1010ₙ, a determined risk score exceeds a predetermined threshold.

According to the non-limiting aspect of FIG. 2, tenant 1010ₙ requirements, such as variability points, that are specific to a particular client organization and/or tenant 1010ₙ architecture can be provided to artifacts stored in the content library 2002. The content library 2002 can achieve this in accordance with a deployable artifact template, as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. For example, the content library 2002 can contain “json” files for defining alert rules, workbooks, playbooks, etc. As new content is added to the content library 2002 or existing content is updated, the changes can be automatically pushed via the SOAR management server 1002 to the SOAR platform 2018 of the tenant 1010ₙ. In other words, the SOAR management server 1002, when deployed, can be configured for each tenant's 1010₁₋ₙ (FIG. 1) specific SOAR needs, which will vary based on each tenant's architecture.

The variable store 2004 can be configured to further customize the interface between the SOAR management server 1002 and the tenant 1010ₙ, or client organization's, architecture. For example, the variable store 2004 can enable a user of the SOAR management server 1002, such as an MSSP, to define and/or link variables associated with the tenant 1010ₙ architecture, as detected by the SOAR management server 1002, to various artifacts stored in the content library 2002, which enhances the ability of the SOAR management server 1002 to automate a client-specific implementation. According to some non-limiting aspects, variables can be stored using a primary key that indicates the destination environment uniquely. For example, when onboarding an environment to be managed, an MSSP, or another user, can indicate admin accounts tied to the environment so that they could be configured when content is being deployed to that particular environment. Accordingly, an automation being deployed may need to be fed which accounts are administrators so that it runs automations specific to those account roles.

The automation schema 2008 can be configured to recognize commonalities between various tenant 1010₁₋ₙ (FIG. 1) architectures and standardize the implementation of the SOAR management server 1002. This represents a significant technological improvement beyond a conventional SOAR management platform, which is configured to either be implemented for a single client organization or would require a significant amount of manual labor to implement across multiple tenants 1010₁₋ₙ, or client organizations. For example, conventional SOAR platforms require the assessment of client-specific environments and needs, which requires the design and implementation of a custom solution. The automation schema 2008 of FIG. 2, in conjunction with the content library 2002 and the variable store 2004, enable the SOAR management server 1002 of FIGS. 1 and 2 to automatically generate customized SOAR solutions and scale such solutions across an unprecedented number of tenants 1010₁₋ₙ, or client organizations, simultaneously.

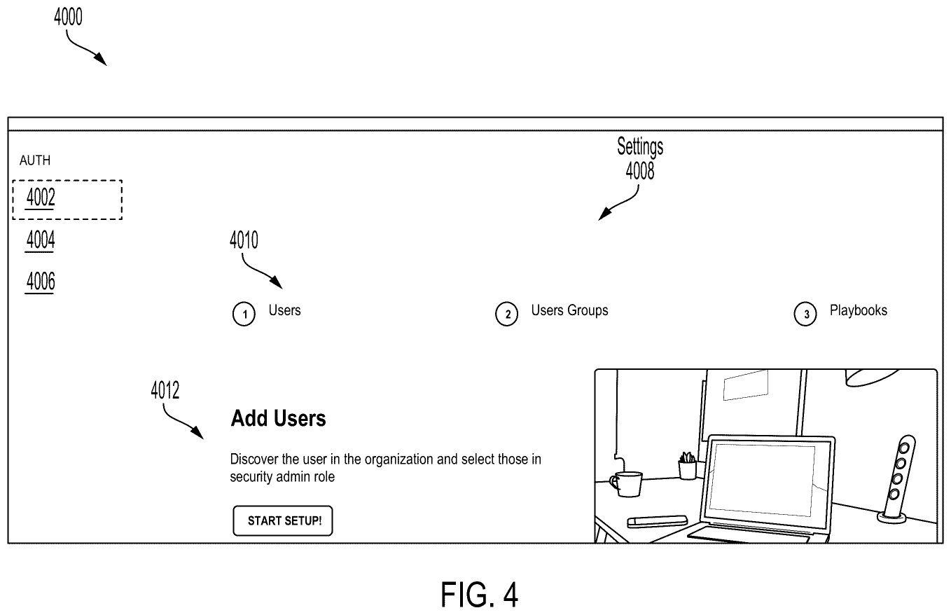

The application launched by the SOAR management server 1002 can further include an API broker 2006 and a graphical user interface 2010. An example of one such graphical user interface 4000, according to one non-limiting aspect, is depicted in FIG. 4. For example, the graphical user interface 4000 of FIG. 4 can include one or more platforms 4002, 4004, 4006 to manipulate the authorization settings. The platforms can be third-party applications that act as authentication mechanisms such as, for example, Okta 4002, Duo 4004, and/or Azure AD 4006, amongst others. Once a platform 4002 is selected, the graphical interface can display a settings wizard 4008. The settings wizard 4008 can include one or more windows 4010, which enable the user to configure various settings for various parameters, such as users, user groups, and/or remediation playbooks. Each window 4010, when selected, can display instructions 4012 through which the user can configure the specific settings for that parameter configured to visually present information and receive user inputs via a display and/or a peripheral device (e.g., keyboard, mouse, touchscreen, etc.) communicably coupled to the SOAR management server 1002. For example, the graphical user interface 2010 can be configured to run a wizard through which a user may control the setup and/or automation of the SOAR platform for one or more tenants 1010ₙ, or client organizations.

In further reference to FIG. 2, an example of one such tenant 1010ₙ architecture is depicted in accordance with at least one non-limiting aspect of the present disclosure. The SOAR management server 1002 can be configured to detect variables associated with the tenant 1010ₙ architecture, as well as design and deploy a tenant 1010ₙ specific configuration including one or more of the modules illustrated in FIG. 2. For example, according to the non-limiting aspect of FIG. 2, the tenant 1010ₙ architecture can include a remote SOAR platform 2018, a dashboard/reporting module 2022, and one or more security tool application program interfaces (“API's”) 2020_{a-d}. Each security tool API 2020_{a-d} can be configured to prevent malicious attacks on, or misuse of, a client's API's deployed on the tenant 1010ₙ. Because APIs have become key to programming web-based interactions, they have become a target for hackers. Thus, the security tool API's 2020_{a-d} can monitor the client's API's and transmit an alert 2030 back to the SOAR platform 2018 if a suspicious event is detected.

According to some non-limiting aspects, the dashboard/reporting module 2022 can include a customizable, visual representation of the tenent's 1010ₙ cyber security. For example, dashboard/reporting module 2022 can enable the MSSP and/or employees of the client organization to see what is happening across the tenant 1010ₙ network and take remedial actions to secure the network in response to identified threats. This can help the MSSP and/or client organization identify, prevent, mitigate, and/or predict cybersecurity incidents in a significantly more efficient way. Of course, the specific tenant 1010ₙ architecture of FIG. 2 is merely presented for illustrative purposes. According to other non-limiting aspects, the tenant 1010ₙ architecture designed and deployed by the SOAR management server 1002 can be alternately configured to include alternate types and/or quantities of modules. The ability of the SOAR management server 1002—and more specifically, the content library 2002, the variable store 2004, and the automation schema 2008—enables customized SOAR-based solutions that can be remotely managed on behalf of the tenant 1010ₙ. Each solution is different, depending on the variables detected by the variable store 2004 and artifacts selected from the content library 2002 based on the detected variables, as deployed by the SOAR management server 1002.

Moreover, the architecture 2000 of FIG. 2 further illustrates different means of communication between the various modules of the SOAR management server 1002 and the one or more tenants 1010ₙ. For example, certain modules, such as the API broker 2006 may communicate with other modules, such as the service operation engine 2012, the graphical user interface 2010, the remote SOAR platform 2018, and the dashboard/reporting module 2022 via a service layer 2024. Other modules, such as the content library 2002, the variable store 2004, and the API broker 2006, may communicate with the remote SOAR platform 2018 of the tenant 1010ₙ via a management and content delivery layer 2026. The remote SOAR platform 2018 may communicate with the one or more security tool API's 2020_{a-c} of the tenant 1010ₙ via a SOAR communication protocol 2028. The one or more security tool APIs may communicate alerts back to the remote SOAR platform 2018 in accordance with rules defined by the applied artifacts 2032 from the content library 2002, as defined by variables from the variable store 2004, via an alert protocol 2030. The influence that the selected artifacts from the content library 2002 and the detected variables from the variable store 2004 have on the artifacts 2032 are illustrated in FIG. 2 via corresponding cross-hatching. In other words, although similar or the same protocols and/or methods can be applied, each means of communication can include different content. Thus, an end user can leverage the architecture 2000 of FIG. 2 either with or without a specific Managed Detection and Response (“MDR”) service on top. However, when delivered with a specific MDR service, the same APIs can be used with the specific MDR service users interfacing with the APIs, managing the architecture 2000, and taking actions on behalf of one or more tenants.

As is illustrated in the non-limiting aspect of FIG. 2, the various modules of the architecture of the SOAR management server 1002 may be configured to communicate with, manage, and control the remote SOAR platform 2018 of the tenant 1010ₙ in accordance with specific artifacts 2032 from the content library 2002, which are autonomously selected variables associated with the tenant 1010ₙ, as determined by and/or previously stored in the variable store 2004. Accordingly, the content library 2002 and variable store 2004, in conjunction with the automation schema 2008, can enable the SOAR management server 1002 to autonomously generate a custom configuration to integrate with and remotely manage each tenant's 1010ₙ SOAR platform 2018. For example, an artifact 2032 can define the means by which the API broker 2006 and service operation engine 2012 of the SOAR management server 1002 interface with the remote SOAR platform 2018 of the tenant 1010ₙ. Additionally, artifacts 2032 can further define the content alerts 2030 and the conditions under which they are sent from the one or more security tool API's 2020_{a-d} to the remote SOAR platform 2018.

The SOAR management server 1002, including the content library 2002, variable store 2004, and automation schema 2008, can provide a powerful cloud-based tool by which MSSP's can remotely manage a client organizations SOAR platform 2018. Although the primary interface is the graphical user interface 2010, the API interface 2006 can further allow programmatic control of SOAR platform 2018 management capabilities, which enables a user to deploy content in the form of playbooks, automations, integrations, dashboards, and other SOAR controlling code-based content to remote environments, such as the tenant 1010ₙ, through a central interface. Additionally, the content library 2002, variable store 2004, and automation schema 2008 of the SOAR management server 1002 provide features that allow the customization of that content and allow for bespoke deployments based on tenant 1010ₙ specific needs. In other words, the SOAR management server 1002 can provide a modular and extensible way of referencing a stored library of code and content (e.g., the content library 2002) such that options may be autonomously decided at the time of deployment.

For example a user could deploy a series of artifacts stored in the content library 2002, such as playbooks, code, integrations, and/or dashboards, that can enable the integration of a next-generation antivirus (“NGAV”) product, an email security product, and/or an identity protection product and subsequently automate the stages of detection, investigation, and response based on controls they received from the user via the graphical user interface 2010. Additionally and/or alternatively, the SOAR management server 1002 can enable a user to automate a portion of the tenant's 1010ₙ architecture or environment. Moreover, the graphical user interface 2010 can enable a user to “opt in” and/or “opt out” of automated features, as presented by the automation schema 2008, via an easy to follow wizard-like, walk through, application. The user can further customize reporting and/or dashboarding features and preferences to be applied via the dashboard/reporting module 2022, which can be packaged for deployment alongside the automated content.

According to some non-limiting aspects, the application launched by the SOAR management server 1002 can be extensible, meaning it can be configured with the ability to extend or stretch in terms of the number of tenants 1010ₙ whose SOAR platforms 2018 it can remotely manage (e.g., scalability) and/or the number of SOAR management capabilities it provides. In other words, the application, including the content library 2002, the variable store 2004 and the automation schema 2008, can be designed to minimize the level of effort required to enable the SOAR management server 1002 to be extended for future use. For example, through an extensibility mechanism provided by the application launched by the SOAR management server 1002, pluggable add-ons configured to enable additional service components and features of the SOAR management server 1002 can be deployed in the future.

According to some non-limiting aspects, the extensibility mechanism can be implemented in various ways to allow plugging in additional SOAR service components. For example, authentication mechanisms, such as DUO, Okta, amongst others, can be supported concurrently (as illustrated via the graphical user interface 4000 of FIG. 4). These authentication mechanisms may not be hard coded, but configuration files can be discoverable (e.g., the main “config” file for each of the authentication mechanisms can be placed in a well known repository location that is being scanned for new or deleted files). If a new configuration, such as Azure AD, is going to also be supported, the corresponding configuration file for Azure AD will be placed in the same repository location as Duo and Okta configs, and will be discovered by the application management server and presented to users to select from and configure at a client, as needed. The configuration file can comply to a schema defined and understood by this application management tool, and the user interface 4000 (FIG. 4) elements 4002, 4004, 4006 (FIG. 4) can be generated and populated accordingly. Notably, the SOAR applications discussed herein are built in a way to easily be extended with additional configuration capabilities that are not hard coded in its source code, but plugged in dynamically, through new configurations in accordance with this method.

When the user deploys these add-ons via automation, it can trigger the application launched by the SOAR management server 1002 to enable additional subscription-based services on behalf of the MSSP, which can enhance the tenant's 1010ₙ security and health monitoring. Additionally and/or alternatively, the application deployed by the SOAR management server 1002 can be configured to work with existing “unmanaged” content, which may enable at least some discovery and light management of the previous SOAR assets that are already deployed by the tenant 1010ₙ, in lieu of generating a completely new and customized tenant 1010ₙ architecture, as is depicted in FIG. 2.

As previously discussed, when executed by the processor 1004 (FIG. 1), the application can be configured to abstractly and/or dynamically manage a client organization's SOAR platform 2018. For example, in an abstract implementation, the SOAR management server 1002 can employ generically-defined artifacts (e.g., automations) that are stored in the content library 2002, as disclosed in U.S. Provisional Patent Application No. 63/196,458 titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS and filed Jun. 3, 2021, the disclosure of which is hereby incorporated by reference in its entirety. Generically-defined artifacts, for example, can include a block of executable code. However, platform-specific implementations can be subsequently provided (e.g., Azure Defender, Crowdstrike, etc.). Abstract automations/playbooks can be written in a generic format and subsequently translated to a specific format upon deployment. For example, an automation/playbook can be created that is particularly configured to deactivate a user's email account in the event of a business email compromise. However, upon actual implementation of that automation/playbook in a particular customer environment, the system 1000 (FIG. 1) and functional architecture 2000 (FIG. 2) disclosed herein can translate generically written content into a version which is specifically implemented for the specific mail application a tenant is using. In this way, content can be generated that can be adapted programmatically to multiple environments without having to rewrite it, unlike convention systems and architectures. Accordingly, the system 1000 (FIG. 1) and functional architecture 2000 (FIG. 2) disclosed herein provides a significant technological solution—flexibile formats and interface—to a technological problem—incompatability of conventional automations/playbooks, which enables users to scale services to a number of tenant's and their authentication mechanisms.

Alternately, in a dynamic implementation, the SOAR management server 1002 can dynamically generate new automation types via the content library 2002, which can be automatically detected by, and displayed for selection via, the graphical user interface 2010 for subsequent deployment. Similarly, new automations, such as endpoint monitoring solutions (e.g., CarbonBlack, etc.), can be added to the content library 2002 for a given automation type, such as those that block the execution of harmful programs detected by the automations (e.g., block executable file automations, etc.). Similar to, and it becomes automatically available to the GUI, and can be deployed to the appropriate client SOARs (that use those security tools).

Upon deployment via the SOAR management server 1002, tenant 1010ₙ, or client, specific variability points can be detected by the variable store 2004 and correlated to artifacts stored in the content library 2002. For example, the SOAR management server 1002 has the ability to configure automatic response/remediation actions (e.g., playbooks) for a given configuration. These remediation actions can require an optional step, for ecample, the tenant may have to first approve the action. So, while the configuration of a remediation automation may involve similar configuration for the actual tasks (e.g., block an account), the approval step may be done manually through a phone call, or an email, or a workflow form (e.g., integration via sevice tickets). As such, the approval step can be variable (e.g., may or may not exist, and when it exists it may be accomplished in a number of ways), requiring pulling the appropriate code and configuration from the automation repository to configure for this client and SOAR automation.

Thus, at deployment, the variability points can be configured for tenant 1010ₙ specific SOAR needs, based on the network architecture of the tenant 1010ₙ. According to one non-limiting aspect, the SOAR management server 1002 may automate the SOAR platform 2018 to block a user account upon detection of a security event based on inputs received by the security tool API's 2020_{a-d}. For example, the automation may include a number of steps or conditions, such as approval from a tenant 1010ₙ administrative account. During the deployment—for example via a wizard presented via the graphical user interface 2010—the automation may request the user to provide information (e.g., a phone number, a short message service (“SMS”) address, an email address, etc.) associated with one or more administrative accounts for the tenant 1010ₙ. Thus, particular steps and/or conditions, such as contacting and/or prompting action from the administrative account, can be programmed into the automation via the graphical user interface 2010.

According to one non-limiting aspect, upon running the custom automation, the SOAR management server 1002—and more specifically, the custom automation generated by the SOAR management server 1002—can manage the SOAR platform 2018 to detect a security event based on inputs/alerts received from one or more security tool API's 2020_{a-d}, and determine that a user account should be blocked. The SOAR management server 1002 can manage the SOAR platform 2018 to notify the administrative account and the automation will wait for approval, and, upon receiving the approval, can continue on to subsequent steps of the automation, ultimately resulting in the removal of the suspect account from the tenant 1010ₙ network. As described earlier, this can be abstracted into the automation type, with specific implementations for each security tool API 2020_{a-d} and/or notification method. Removing a suspect account is just one example of actions the SOAR platform 2018 can take to enhance the security of a tenant 1010ₙ network. For example, aside from blocking an account, the SOAR platform 2018 can also delete a suspect file, email to the security administrator, amongst other actions.

Once deployed by the SOAR management server 1002, the artifacts 2032 (e.g., automations) can reside in the tenant's 1010ₙ architecture and, depending on the non-limiting aspect, the MSSP and/or the client can modify the deployed configuration. For example, according to some non-limiting aspects, the client may desire to control the deployed configuration across the tenant 1010ₙ network. However, according to other non-limiting aspects, the client may desire for the MSSP to have exclusive control of the configuration. Regardless, the application deployed by the SOAR management server 1002 can be configured to automatically detect changes made by the MSSP and/or the client and use them for future deployments and/or the management of updates to the already deployed artifacts 2032. According to some non-limiting aspects, such changes can be utilized by an artificial intelligence stored on the memory 1006 (FIG. 1) of the SOAR management server 1002 to adapt one or more artifacts 2032 (e.g., templates, workflows, etc.) in the content library 2002 for enhanced deployments for similar clients and/or architectures.

Accordingly, the content library 2020 can serve as a contribution mechanism that, when deployed by the application on the SOAR management server 1002, along with the graphical user interface 2010 and API broker 2006, can abstractly and/or dynamically detect updates to both the content library 2002 and the client's SOAR platform 2018. These updates can be collectively managed through the SOAR management server 1002, which serves as a central console for the system 1000 (FIG. 1), and can enable unprecedented scalability to manage a great number of clients. As such, the SOAR management server 1002 can remotely manage another client's SOAR platform 2018 with reliability and consistency. Due to its modular design, it can also be “future proofed,” allowing users and third party applications to contribute new artifacts 2032 and/or update existing artifacts 2032 them, as third party vendor solutions evolve.

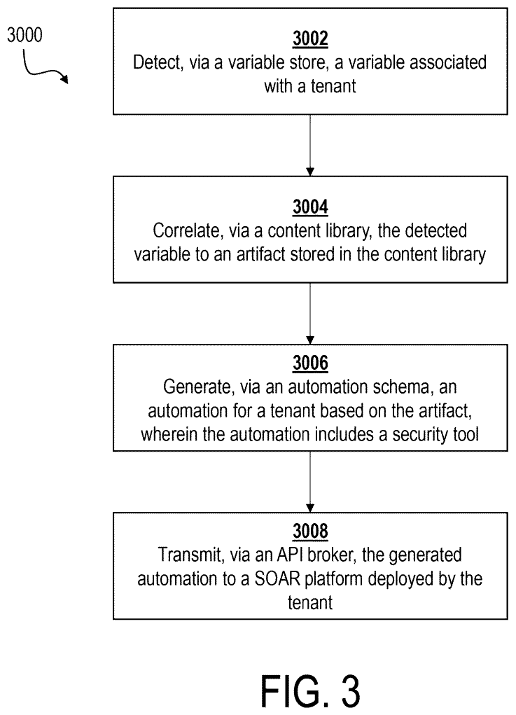

Referring now to FIG. 3, a method 3000 of remotely managing another organization's SOAR platform 2018 (FIG. 2) is depicted in accordance with at least one non-limiting aspect of the present disclosure. According to the non-limiting aspect of FIG. 3, the method 3000 can be performed by a SOAR management server 1002 (FIGS. 1 and 2). Specifically, a SOAR management application stored in a memory 1006 (FIG. 1), including a content library 2002 (FIG. 2), a variable store 2004 (FIG. 2), an automation schema 2008 (FIG. 2), and an API broker 2006 (FIG. 2) can cause a processor 1004 (FIG. 1) of the SOAR management server 1002 (FIGS. 1 and 2) to perform the method 3000. The method 300 can include detecting 3002, via the variable store 2004 (FIG. 2), a variable associated with the tenant. Once the variable is detected, the method 3000 can include correlating 3004, via the content library 2002 (FIG. 2), the detected variable to an artifact 2032 (FIG. 2) stored within the content library 2002 (FIG. 2). The method 3000 can further include generating 3006, via the automation schema 2008 (FIG. 2), an automation for a tenant 1010ₙ (FIG. 2) based on the artifact 2032 (FIG. 2), wherein the automation can include a security tool 2020_{a-d} (FIG. 2) configured to continuously monitor one or more APIs deployed by the tenant 1010ₙ (FIG. 2). The method 3000 can further include transmitting 3008, via the API broker 2006 (FIG. 2), the generated automation to the SOAR platform 2018 (FIG. 2) deployed by the tenant 1010ₙ (FIG. 2).

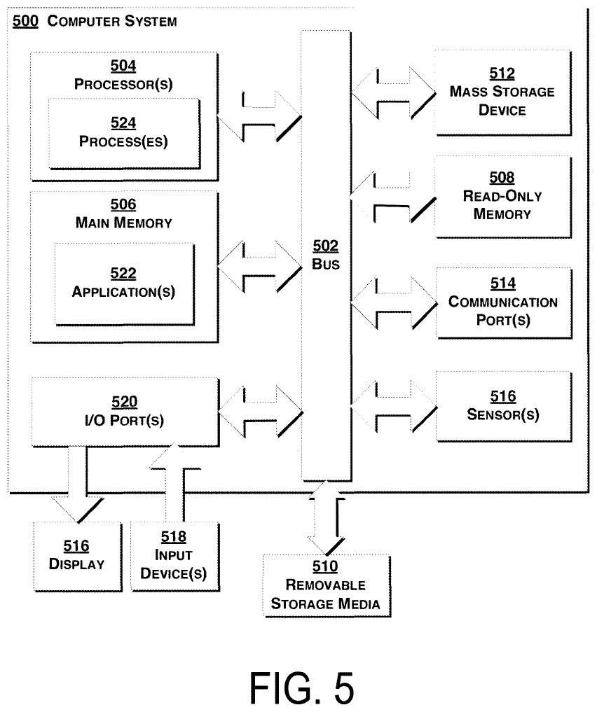

Referring now to FIG. 5, a scalable security information and event management framework computer system 500 is depicted, as originally described in U.S. Pat. No. 10,708,123, titled SCALABLE SECURITY INFORMATION AND EVENT MANAGEMENT (SIEM) FRAMEWORK and filed Apr. 24, 2019, the disclosure of which is herein incorporated by reference in its entirety. Specifically, FIG. 5 depicts a schematic diagram of a computer system 500 upon which embodiments described in the present disclosure may be implemented and carried out. According to one non-limiting aspect the computer system 500 may include a bus 502 (i.e., interconnect), one or more processors 504, a main memory 506, read-only memory 508, removable storage media 510, mass storage 512, and one or more communications ports 514. As should be appreciated, components such as removable storage media are optional and are not necessary in all systems. Communication port 514 may be connected to one or more networks by way of which the computer system 500 may receive and/or transmit data. As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process. Processor(s) 504 can be any known processor, such as, but not limited to, processors manufactured by and/or sold by INTEL®, AMD®, or MOTOROLA®, and the like, that are generally well-known to one skilled in the relevant art and are well-defined in the literature. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used. Bus 502 communicatively couples processor(s) 504 with the other memory, storage, and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Various aspects of the subject matter described herein are set out in the following numbered clauses:

Clause 1: A security automation platform communicably coupled to a tenant configured to deploy a tenant security platform, wherein the security automation platform includes: a processor; and a memory configured to store a security automation application including a content library, a variable store, an automation schema, and an application program interface (API) broker, and wherein, when executed by the processor, the security automation application causes the processor to: detect, via the variable store, a variable associated with the tenant; correlate, via the content library, the detected variable to an artifact stored within the content library; generate, via the automation schema, an automation for the tenant based on the artifact, wherein the automation includes a security tool configured to continuously monitor an API deployed by the tenant security platform; and transmit, via the API broker of the security automation application, the generated automation to the SOAR platform deployed by the tenant.

Clause 2: The security automation platform according to clause 1, wherein the automation includes a security tool configured to continuously and autonomously monitor the API, and wherein, when executed by the processor, the security automation application further causes the processor to: detect, via the security tool, a security event associated with the API deployed by the tenant security platform; generate, via the automation, an alert associated with the detected security event; and transmit, via the automation, the alert to the tenant security platform deployed by the tenant.

Clause 3: The security automation platform according to either of clauses 1 or 2, wherein the alert provides a recommended action to mitigate the detected security event.

Clause 4: The security automation platform according to any of clauses 1-3, wherein the detected security event is associated with a suspect account, and wherein the recommended action includes removing, via the tenant security platform, a network access associated with the suspect account.

Clause 5: The security automation platform according to any of clauses 1-4, wherein the recommended action requires approval from an administrative account of the tenant prior to removing the network access of the suspect account.

Clause 6: The security automation platform according to any of clauses 1-5, wherein the artifact includes at least one of a detection, a workbook, an alert rule, a playbook, or combinations thereof.

Clause 7: The security automation platform according to any of clauses 1-6, wherein the security automation platform is configured to automatically update the artifact based on the detected variable associated with the tenant for future use.

Clause 8: The security automation platform according to any of clauses 1-7, wherein the tenant is one of a plurality of tenants, wherein the tenant security platform is one of a plurality of tenant security platforms deployed by the plurality tenants, and wherein the security automation platform is further configured to simultaneously manage each of the plurality of tenant security platforms deployed by the plurality of tenants.

Clause 9: The security automation platform according to any of clauses 1-8, wherein the security automation application further includes a graphical user interface configured to receive a user input, and wherein the user input includes an instruction associated with the management of the tenant security platform deployed by the tenant.

Clause 10: A method for enhancing network security via a Security Orchestration, Automation, and Response (SOAR) management server communicably coupled to a tenant configured to deploy a SOAR platform, wherein the SOAR management server includes a processor; and a memory configured to store a SOAR management application including a content library, a variable store, an automation schema, and an application program interface (API) broker, the method including: detecting, via the variable store, a variable associated with the tenant; correlating, via the content library, the detected variable to an artifact stored within the content library; generating, via the automation schema, an automation for the tenant based on the artifact, wherein the automation includes a security tool configured to continuously monitor an API deployed by the tenant; and transmitting, via the API broker of the SOAR management application, the generated automation to the SOAR platform deployed by the tenant.

Clause 11: The method according to clause 10, further including: detecting, via the security tool, a security event associated with the API deployed by the tenant; generating, via the automation, an alert associated with the detected security event; and transmitting, via the automation, the alert to the SOAR platform deployed by the tenant, wherein the alert provides a recommended action to mitigate the detected security event.

Clause 12: The method according to either of clauses 10 or 11, wherein the detected security event is associated with a suspect account, and wherein the recommended action includes removing, via the SOAR platform, a network access associated with the suspect account.

Clause 13: The method according to any of clauses 10-12, further including automatically updating, via the content library, the artifact based on the detected variable associated with the tenant for future use.

Clause 14: A system for enhancing network security by remotely managing a SOAR platform, the system including: a tenant configured to deploy the SOAR platform; and a Security Orchestration, Automation, and Response (SOAR) management server communicably coupled to the tenant, wherein the SOAR management server includes a processor, and a memory, wherein the memory is configured to store a SOAR management application including a content library, a variable store, an automation schema, and an application program interface (API) broker, and wherein, when executed by the processor, the SOAR management application causes the processor to: detect, via the variable store, a variable associated with the tenant; correlate, via the content library, the detected variable to an artifact stored within the content library; generate, via the automation schema, an automation for the tenant based on the artifact, wherein the automation includes a security tool configured to continuously monitor an API deployed by the tenant; transmit, via the API broker of the SOAR management application, the generated automation to the SOAR platform deployed by the tenant.

Clause 15. The system according to clause 14, wherein, when executed by the processor, the security automation application further causes the processor to: detect, via the security tool, a security event associated with the API deployed by a tenant security platform deployed by a tenant; generate, via the automation, an alert associated with the detected security event; and transmit, via the automation, the alert to the tenant security platform deployed by the tenant.

Clause 16. The system according to either of clauses 14 or 15, wherein the alert provides a recommended action to mitigate the detected security event.

Clause 17. The system according to any of clauses 14-16, wherein the detected security event is associated with a suspect account, and wherein the recommended action includes removing, via the tenant security platform, a network access associated with the suspect account.

Clause 18. The system according to any of clauses 14-17, wherein the recommended action requires approval from an administrative account of the tenant prior to removing the network access of the suspect account.

Clause 19. The system according to any of clauses 14-18, wherein the artifact includes at least one of a detection, a workbook, an alert rule, a playbook, or combinations thereof.

Clause 20. The system according to any of clauses 14-19, when executed by the processor, the security automation application further causes the processor to automatically update the artifact based on the detected variable associated with the tenant for future use.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

What is claimed is:

1. A security automation platform communicably coupled to a tenant configured to deploy a tenant security platform, the security automation platform comprising:
a processor; and
a memory configured to store a security automation application comprising a content library, a variable store, an automation schema, and an application program interface (API) broker, and wherein, when executed by the processor, the security automation application causes the processor to:
detect, via the variable store, a variable associated with the tenant;
correlate, via the content library, the detected variable to an artifact stored within the content library;
generate, via the automation schema, an automation for the tenant based on the artifact, wherein the automation comprises a security tool configured to continuously monitor an API deployed by the tenant security platform; and
transmit, via the API broker of the security automation application, the generated automation to the tenant security platform deployed by the tenant.

2. The security automation platform of claim 1, wherein, when executed by the processor, the security automation application further causes the processor to:
detect, via the security tool, a security event associated with the API deployed by the tenant security platform;
generate, via the automation, an alert associated with the detected security event; and
transmit, via the automation, the alert to the tenant security platform deployed by the tenant.

3. The security automation platform of claim 2, wherein the alert provides a recommended action to mitigate the detected security event.

4. The security automation platform of claim 3, wherein the detected security event is associated with a suspect account, and wherein the recommended action comprises removing, via the tenant security platform, a network access associated with the suspect account.

5. The security automation platform of claim 4, wherein the recommended action requires approval from an administrative account of the tenant prior to removing the network access of the suspect account.

6. The security automation platform of claim 1, wherein the artifact comprises at least one of a detection, a workbook, an alert rule, a playbook, or combinations thereof.

7. The security automation platform of claim 6, wherein the security automation application is configured to automatically update the artifact based on the detected variable associated with the tenant for future use.

8. The security automation platform of claim 1, wherein the tenant is one of a plurality of tenants, wherein the tenant security platform is one of a plurality of tenant security platforms deployed by the plurality tenants, and wherein the security automation platform is further configured to simultaneously manage each tenant security platform deployed by the plurality of tenants.

9. The security automation platform of claim 1, wherein the security automation application application further comprises a graphical user interface configured to receive a user input, and wherein the user input comprises an instruction associated with the management of the tenant security platform deployed by the tenant.

10. A method for enhancing network security via a Security Orchestration, Automation, and Response (SOAR) management server communicably coupled to a tenant configured to deploy a SOAR platform, wherein the SOAR management server comprises a processor; and
a memory configured to store a SOAR management application comprising a content library, a variable store, an automation schema, and an application program interface (API) broker, the method comprising:
detecting, via the variable store, a variable associated with the tenant;
correlating, via the content library, the detected variable to an artifact stored within the content library;
generating, via the automation schema, an automation for the tenant based on the artifact, wherein the automation comprises a security tool configured to continuously monitor an API deployed by the SOAR platform; and
transmitting, via the API broker of the SOAR management application, the generated automation to the SOAR platform deployed by the tenant.

11. The method of claim 10, further comprising:
detecting, via the security tool, a security event associated with the API deployed by the SOAR platform;
generating, via the automation, an alert associated with the detected security event; and transmitting, via the automation, the alert to the SOAR platform deployed by the tenant, wherein the alert provides a recommended action to mitigate the detected security event.

12. The method of claim 11, wherein the detected security event is associated with a suspect account, and wherein the recommended action comprises removing, via the SOAR platform, a network access associated with the suspect account.

13. The method of claim 12, further comprising automatically updating, via the content library, the artifact based on the detected variable associated with the tenant for future use.

14. A system for enhancing network security by remotely managing a Security Orchestration, Automation, and Response (SOAR) platform, the system comprising:
a tenant configured to deploy the SOAR platform; and
a SOAR management server communicably coupled to the tenant, wherein the SOAR management server comprises a processor, and a memory configured to store a SOAR management application comprising a content library, a variable store, an automation schema, and an application program interface (API) broker, and wherein, when executed by the processor, the SOAR management application causes the processor to:
detect, via the variable store, a variable associated with the tenant;
correlate, via the content library, the detected variable to an artifact stored within the content library;
generate, via the automation schema, an automation for the tenant based on the artifact, wherein the automation comprises a security tool configured to continuously monitor an API deployed by the SOAR platform;
transmit, via the API broker of the SOAR management application, the generated automation to the SOAR platform deployed by the tenant.

15. The system of claim 14, wherein, when executed by the processor, the security automation application further causes the processor to:
detect, via the security tool, a security event associated with the API deployed by a tenant security platform deployed by a tenant;
generate, via the automation, an alert associated with the detected security event; and
transmit, via the automation, the alert to the tenant security platform deployed by the tenant.

16. The system of claim 15, wherein the alert provides a recommended action to mitigate the detected security event.

17. The system of claim 16, wherein the detected security event is associated with a suspect account, and wherein the recommended action comprises removing, via the tenant security platform, a network access associated with the suspect account.

18. The system of claim 17, wherein the recommended action requires approval from an administrative account of the tenant prior to removing the network access of the suspect account.

19. The system of claim 14, wherein the artifact comprises at least one of a detection, a workbook, an alert rule, a playbook, or combinations thereof.

20. The system of claim 6, when executed by the processor, the security automation application further causes the processor to automatically update the artifact based on the detected variable associated with the tenant for future use.
